(19) United States
(12) Patent Application Publication
(10) Pub. No.: US 2011/0241643 A1
(43) Pub. Date: Oct. 6, 2011

(54) POWER CONTROL DEVICE

(75) Inventor: Yasuhiro IINO, Kawasaki (JP)

(73) Assignee: Fujitsu Limited, Kawasaki (JP)

(21) Appl. No.: 13/073,281

(22) Filed: Mar. 28, 2011

(30) Foreign Application Priority Data
Mar. 31, 2010 (JP) 2010-83375

(51) Int. Cl. G05F 1/10

(52) U.S. Cl. 323/293

(57) ABSTRACT

A power control device for the load element includes a variable capacitance element connected in parallel with the load element, and a control unit controlling a capacitance of the variable capacitance element and maintaining a degree of a voltage fluctuation due to a parasitic inductance of the line such that the degree of the voltage fluctuation is not more than a certain degree.

### CROSS-REFERENCE TO RELATED APPLICATIONS

This application is based upon and claims the benefit of priority of the prior Japanese Patent Application No. 2010-83375, filed on Mar. 31, 2010, the entire contents of which are incorporated herein by reference.

### BACKGROUND

1. Field

The embodiments discussed herein are related to a power control device provided to supply power to an information communication apparatus.

2. Description of the Related Art

Load elements such as semiconductor devices including a large scale integration (LSI) circuit, a central processing unit (CPU), a field programmable gate array (FPGA), and so forth are provided in an information communication apparatus such as a server apparatus or a network apparatus. In recent years, the server apparatus, the network apparatus, or the like operates at high speed. Therefore, the operating voltage of the load element has been decreased, while the operating current and the processing speed of the load element have been increased.

Therefore, it is important for a power supply device configured to supply power to the load elements to achieve a high-speed response characteristic appropriate for the load elements, so as to supply power to the load elements with stability.

Increasing a switching frequency may be an exemplary method of improving the characteristics of the power supply device. However, increasing the switching-frequency raises the issue of the power conversion capabilities, the heat liberation, or the like.

Usually, power is supplied from a power supply device arranged on a printed wiring board to a load element such as a semiconductor device via wires provided on the printed wiring board. However, even though the power supply device is arranged near the load element, it is difficult to reduce the voltage fluctuations, because a parasitic inductance exists in the wires extending from the power supply device to the load element.

In particular, the above-described tendency has become increasingly significant as the performance of the load element such as the semiconductor device has been improved in recent years. For example, the operating voltage of the load element on the order of 3.3 to 5.0 volts has been decreased to that of 1.0 to 1.8 volts and the operating current thereof on the order of a few amperes has been increased to that of several tens to several hundreds of amperes in recent years. Further, with an increase in the processing speed of the load element, the current change rate of the load element has been increased from the order of milliseconds to the order of microseconds.

FIG. 1 illustrates a large-capacity capacitor 4 connected near and in parallel with a load element 3 connected to a power supply device 1 via a wire 2. In FIG. 1, a parasitic inductance existing in the wire 2 is expressed as an inductance L_{S}. The capacitor 4 reduces the voltage fluctuations due to the above-described parasitic inductance and allows the load element to operate with stability.

The power supply device 1 is typically used as a point-of-load (POL) power supply. The power supply device 1 is arranged near the load element 3 and is used specifically for the load element 3. The power supply device 1 used as the POL power supply is achieved by, for example, a DC-DC converter. The capacitor 4 is provided as a bypass capacitor. A large number of the capacitors 4 are connected in parallel with one another, so as to reduce high-speed and large-amplitude voltage fluctuations occurring in the wire 2 and to achieve a large capacity. In that case, the capacitance value becomes several thousand μF to several scores of thousand μF, for example.

The capacitor 4 illustrated in FIG. 1 has restrictions in terms of circuit space. According to Japanese Laid-open Patent Publication No. 2009-117697, the voltage fluctuations are reduced by converting a small capacitance value into a large capacitance value using the mirror effect of an amplifier.

As described above, the voltage fluctuations due to the parasitic inductance in the wire are reduced so as to supply power to a load element such as a semiconductor device with stability.

The parasitic inductance of wire is determined based on the length and width of the wire, the positional relationship between a load element and a power supply device, and so forth. Therefore, the capacitance value of a capacitor necessary for supplying power to the load element with stability is changed based on the type of load element, the power supplied to the load element, and so forth.

Since many power supply devices are provided in an information communication apparatus such as a server apparatus or a network apparatus, it is difficult for the information communication apparatus to calculate the capacitance value corresponding to a parasitic inductance existing between the power supply devices and a load element.

### SUMMARY

According to an embodiment, a power control device for the load element includes a variable capacitance element connected in parallel with the load element, and a control unit controlling a capacitance of the variable capacitance element and maintaining a degree of a voltage fluctuation due to a parasitic inductance of the line such that the degree of the voltage fluctuation is not more than a certain degree.

The object and advantages of the invention will be realized and attained by at least the features, elements, and combinations particularly pointed out in the claims.

It is to be understood that both the foregoing general description and the following detailed description are exemplary and explanatory and are not restrictive of the invention, as claimed.

The above-described embodiments of the present invention are intended as examples, and all embodiments of the present invention are not limited to including the features described above.

### BRIEF DESCRIPTION OF THE DRAWINGS

FIG. 1 illustrates a known power control device.

FIGS. 2A and 2B illustrate an information communication apparatus including a power control device according to a first embodiment.

FIG. 3 illustrates an exemplary circuit configuration where a power supply device and a CPU are connected to the power control device according to the first embodiment.

FIG. 4 illustrates an exemplary circuit configuration of a variable capacitance element of the power control device.

FIG. 5 illustrates a control process of a capacitance of the variable capacitance element performed by a control unit of the power control device.

FIG. 6A illustrates the waveform of voltage across terminals of the CPU, when power is supplied under the control of the power control device.

FIG. 6B illustrates a comparative example of the waveform that is compared to the waveform illustrated in FIG. 6A.

FIG. 7 illustrates a variable capacitance element of a power control device according to a second embodiment.

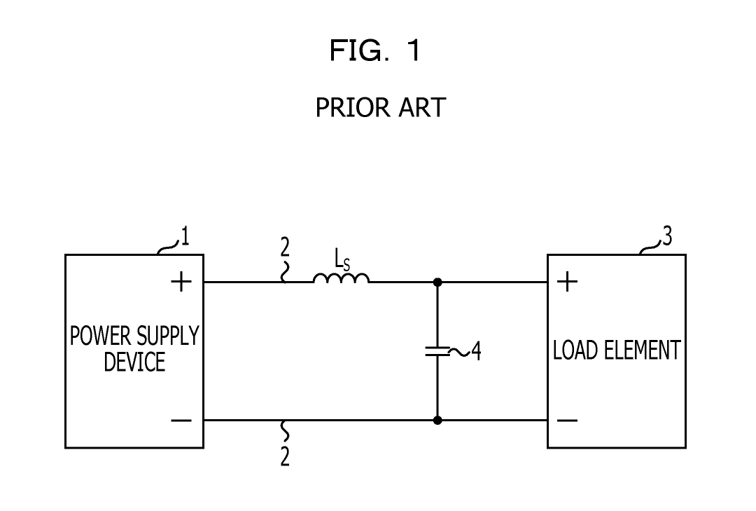

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

### First Embodiment

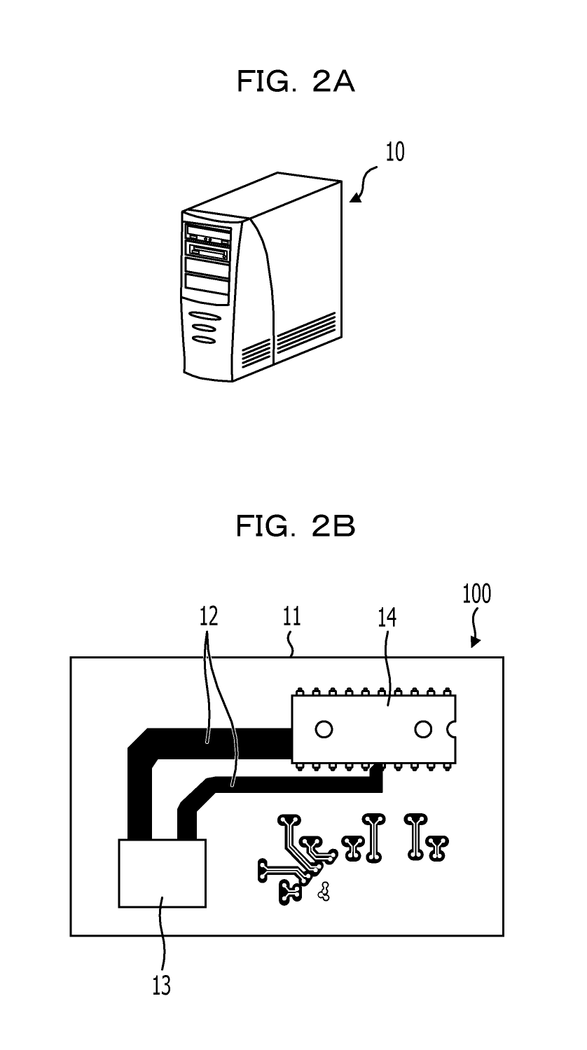

An information communication apparatus illustrated in FIG. 2A is a server 10 including many printed wiring boards 11 that are configured as illustrated in FIG. 2B.

The printed wiring board 11 is, for example, a flame retardant type 4 (FR4), which is a printed wiring board made of glass fibers and epoxy resin. Usually, the print wiring board 11 includes a plurality of insulating layers stacked one on top of another, and patterned copper foil between the insulating layers and on the uppermost face of the stacked structure. FIG. 2B illustrates wires 12 of patterned copper foil, which are provided on the uppermost face of the printed wiring board 11. The wires 12 of the patterned copper foil are also provided between the insulating layers and on the uppermost face of the printed wiring board 11, and include wires used to supply a power voltage, wires used to forward a signal, and wires maintained at a reference potential such as a ground potential.

Further, a power supply device 13 provided as a POL power supply and a CPU 14 provided as an exemplary load element are mounted to the printed wiring board 11, and the power supply device 13 supplies power to the CPU 14 via the wires 12. Although FIG. 2B illustrates the power supply device 13 and the CPU 14 for the sake of description, other electronic component devices are also mounted to the printed wiring board 11.

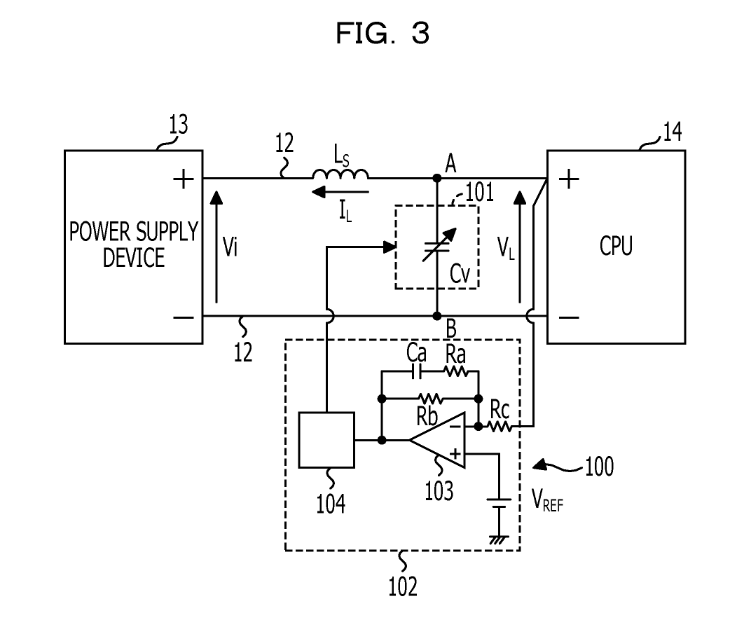

FIG. 3 illustrates a circuit configuration where the power supply device 13 and the CPU 14 are connected to a power control device 100 according to a first embodiment.

The power control device 100 includes a variable capacitance element 101 and a negative feedback circuit 102. The variable capacitance element 101 is connected to the wire 12 connecting the power supply device 13 and the CPU 14 and in parallel with the CPU 14 provided as the exemplary load element. The negative feedback circuit 102 detects a voltage across power terminals 14A and 14B of the CPU 14 and controls the capacitance value of the variable capacitance element 101.

In FIG. 3, the parasitic inductance of the wire 12 is represented by L_{S} and indicated by a symbol for coil. Further, a current passing through the wire 12 is represented by I_{L}, and the amount of voltage fluctuations occurring due to the temporal change of a current passing through the parasitic inductance L_{S} is represented by V_{AS} (=L_{S}·dI_{L}/dt). The voltage across the terminals of the power supply device 13 is represented by Vi and the voltage across the power terminals 14A and 14B of the CPU 14 is represented by V_{L}.

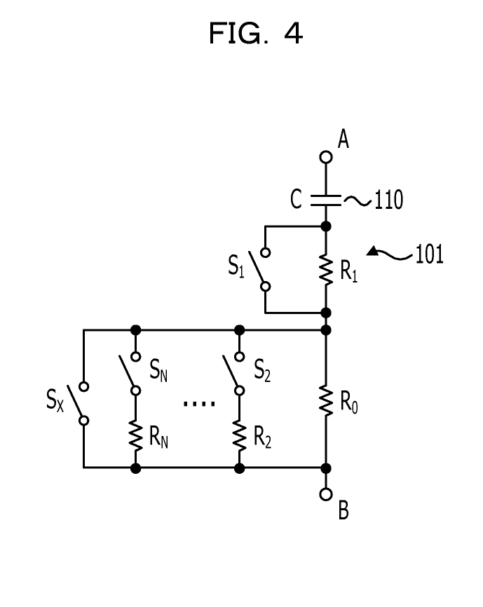

The variable capacitance element 101 is a capacitance element with a changeable capacitance Cv which is feedback-controlled by the negative feedback circuit 102. An exemplary circuit configuration of the variable capacitance element 101 will be specifically described later with reference to FIG. 4.

The negative feedback circuit 102 includes an operational amplifier 103 where the voltage V_{L} across the power terminals 14A and 14B of the CPU 14 is input to the inverting input terminal of the operational amplifier 103 so that the input voltage is compared to a reference voltage (Vref), and a control unit 104 configured to control the capacitance Cv of the variable capacitance element 101 based on an output of the operational amplifier 103. Resistors Ra and Rb, and a capacitor Ca are connected between the inverting input terminal and an output terminal of the operational amplifier 103, and an input resistor Rc is connected to the operational amplifier 103.

The operational amplifier 103 compares the voltage V_{L} across the power terminals 14A and 14B of the CPU 14, which is input to the inverting input terminal, to the reference voltage (Vref). The operational amplifier 103 outputs a negative voltage when the voltage V_{L} becomes higher than the reference voltage (Vref), and outputs a positive voltage when the voltage V_{L} becomes lower than the reference voltage (Vref).

Upon receiving the voltage output from the operation amplifier 103, the control unit 104 performs the feedback control. The control unit 104 increases the capacitance Cv of the variable capacitance element 101 when the value of the negative voltage, which is output when the voltage V_{L} across the power terminals 14A and 14B of the CPU 14 becomes higher than the reference voltage Vref, is not more than a certain voltage value, so that the voltage V_{L} falls within a specific allowable range. The control unit 104 may include, for example, a digital circuit using a CPU and/or an analog circuit using an operational amplifier or the like. In the present embodiment, however, the control unit 104 is provided as the digital circuit using the CPU. The details of processing performed by the control unit 104 will be described later.

Next, an exemplary circuit configuration of the variable capacitance element 101 will be described with reference to FIG. 4.

FIG. 4 illustrates the exemplary circuit configuration of the variable capacitance element 101 provided in the power control device 100 according to the first embodiment. The variable capacitance element 101 includes a capacitor 110 provided as a capacitance element, resistors R₀ to R_{N}, and switches S₁ to S_{N}, and S_{X} that are provided between terminals A and B. Here, N indicates the number of the switches and is an integer of 2 or more. The resistors R₀ and R₁ are connected in series with the capacitor 110. The switch S₁ is connected in parallel with the resistor R₁. N−1 circuits including resistors R₂ to R_{N} that are connected in series with the respective switches S₂ to S_{N}, and the switch S_{X} are connected in parallel with the resistor R₀. The resistors R₀ to R_{N} may be a chip resistor having a certain resistance value, and the switches S₁ to S_{N} and S_{X} may be a small relay, photocoupler, or the like. In the present embodiment, the resistors R₀ to R_{N} have an equal resistance value. The capacitor 110 includes an equivalent series resistance (ESR).

The capacitance Cv of the variable capacitance element 101 is determined based on a capacitance C of the capacitor 110 and the combined resistance value of the resistors R₀ to R_{N} that are connected between the terminals A and B based on the closing/opening state of each of the switches S₁ to S_{N}, and S_{X}.

In the first embodiment, the closing/opening state of each of the switches S₁ to S_{N}, and S_{X} is controlled by the control unit 104. In the initial state, each of the switches S₁ to S_{N}, and S_{X} is open, and the combined resistance value is the maximum value of R0+R1. Therefore, the value of the capacitance Cv of the variable capacitance element 101 is minimized. The control unit 104 closes the switches S₂ to S_{N}, S_{X}, and S₁ in this order. The combined resistance value is decreased as the switches are closed one by one. In other words, the value of the capacitance Cv of the variable capacitance element 101 is gradually increased as the switches are closed one by one from the initial state. After all of the switches S₁ to S_{N}, and S_{X} are closed, the value of the combined resistance becomes zero, and the capacitance Cv of the variable capacitance element 101 is maximized.

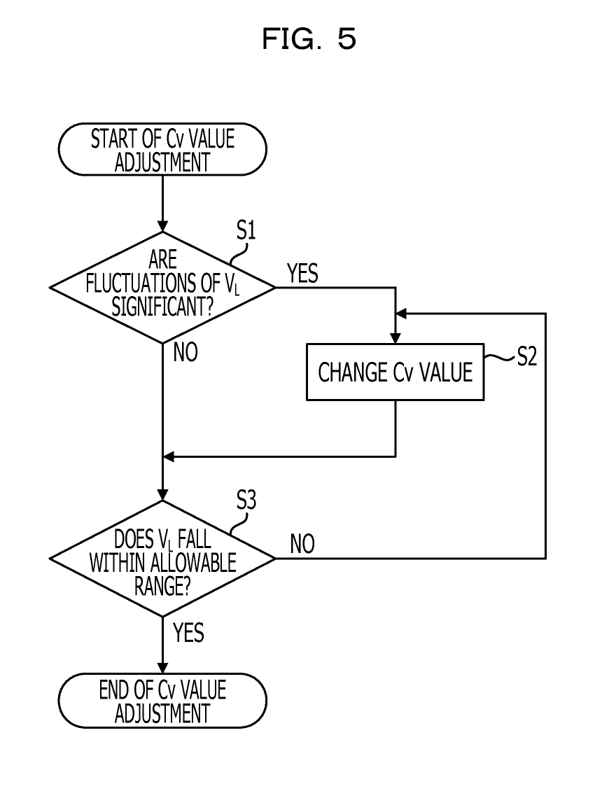

Next, how the capacitance Cv of the variable capacitance element 101 is controlled by the control unit 104 will be described with reference to FIG. 5.

FIG. 5 is a flowchart illustrating a control process of the capacitance Cv of the variable capacitance element 101 performed by the control unit 104 of the power control device 100 according to the first embodiment. The control process is performed at the time when initial settings are made, so as to set the capacitance Cv of the variable capacitance element 101 to the value corresponding to the parasitic inductance of the wire 12 when the power control device 100 is mounted to the server 10, or at the time when the performance of the CPU 14 is evaluated.

After starting the control process, the control unit 104 monitors a voltage output from the operational amplifier 103 and determines whether the value of the voltage output from the operational amplifier 103 is not more than a determination reference value V1 so as to determine whether the fluctuations of the voltage V_{L} across the power terminals 14A and 14B of the CPU 14 are significant (operation S1).

When the voltage V_{L} across the power terminals 14A and 14B of the CPU 14 becomes higher than the reference voltage (Vref) of the operational amplifier 103, the operational amplifier 103 outputs a negative voltage. Therefore, the determination reference value V1 used at operation S1 is set to a negative voltage. The determination reference value V1 is used to detect that the fluctuations of the voltage V_{L} are increased to a certain extent (e.g., to the extent that the operation of the CPU 14 is affected by the fluctuations). Therefore, the determination reference value V1 may be set to a certain negative voltage corresponding to the amount of certain fluctuations of the voltage V_{L} across the power terminals 14A and 14B of the CPU 14. The determination reference value V1 used in the present embodiment may be determined in advance based on, for example, the performance of the CPU 14.

When the value of the voltage output from the operational amplifier 103 is determined to be not more than the determination reference value V1 at operation S1, the control unit 104 performs processing to increase the capacitance Cv of the variable capacitance element 101 (operation S2). At operation S2, the control unit 104 closes the switches S₂ to S_{N}, S_{X}, and S₁ in this order one by one.

After the processing of operation S2 is finished, the control unit 104 monitors a voltage output from the operational amplifier 103, and determines whether or not the amount of fluctuations of the voltage V_{L} across the power terminals 14A and 14B of the CPU 14 falls within a certain range indicating an allowable range (operation S3). The certain range used for the determination of operation S3 is a range indicating that the amount of fluctuations of the voltage V_{L} falls within the allowable range where an increase of the capacitance Cv of the variable capacitance element 101 is unnecessary.

When the voltage V_{L} across the power terminals 14A and 14B of the CPU 14 becomes higher than the reference voltage (Vref) of the operational amplifier 103 as described above, a negative voltage is output from the operational amplifier 103. Therefore, the certain range used for the determination of operation S3 may be set in a range indicating that the value of the voltage output from the operational amplifier 103 is a specific negative voltage value V2 or more.

Further, since the processing of operation S3 is performed to determine whether or not the amount of fluctuations of the voltage V_{L} across the power terminals 14A and 14B of the CPU 14 falls within the allowable range, the fluctuation amount determined at operation S3 is smaller than that determined at operation S1 where it is determined whether or not the amount of fluctuations of the voltage V_{L} is large so as to affect the operation of the CPU 14. Therefore, the negative voltage value V2, which is the lowest limit of the certain range defined to make the determination at operation S3, may be higher than the determination reference value V1 used at operation S1.

When the control unit 104 determines that the amount of fluctuations of the voltage V_{L} across the power terminals 14A and 14B of the CPU 14 does not fall within the certain range indicating the allowable range, the flow returns to operation S2. Then, the control unit 104 closes another switch and the capacitance Cv of the variable capacitance element 101 is increased.

When it is determined that the amount of fluctuations of the voltage V_{L} falls within the certain range indicating the allowable range, the control unit 104 terminates a series of processing operations. Consequently, the capacitance Cv of the variable capacitance element 101 is set to a value which makes the voltage V_{L} fall within the allowable range. It is preferable that the capacitance Cv of the variable capacitance element 101 be set to a value which minimizes the fluctuations of the voltage V_{L} through the process illustrated in the flowchart of FIG. 5.

When it is determined that the value of the voltage output from the operational amplifier 103 is higher than the determination reference value V1 at operation S1, the control unit 104 advances the flow to operation S3, so as to determine whether or not the amount of fluctuations of the voltage V_{L} across the power terminals 14A and 14B of the CPU 14 falls within the allowable range even though it is determined that the amount of fluctuations of the voltage V_{L} is not so significant to affect the operation of the CPU 14 at operation S1.

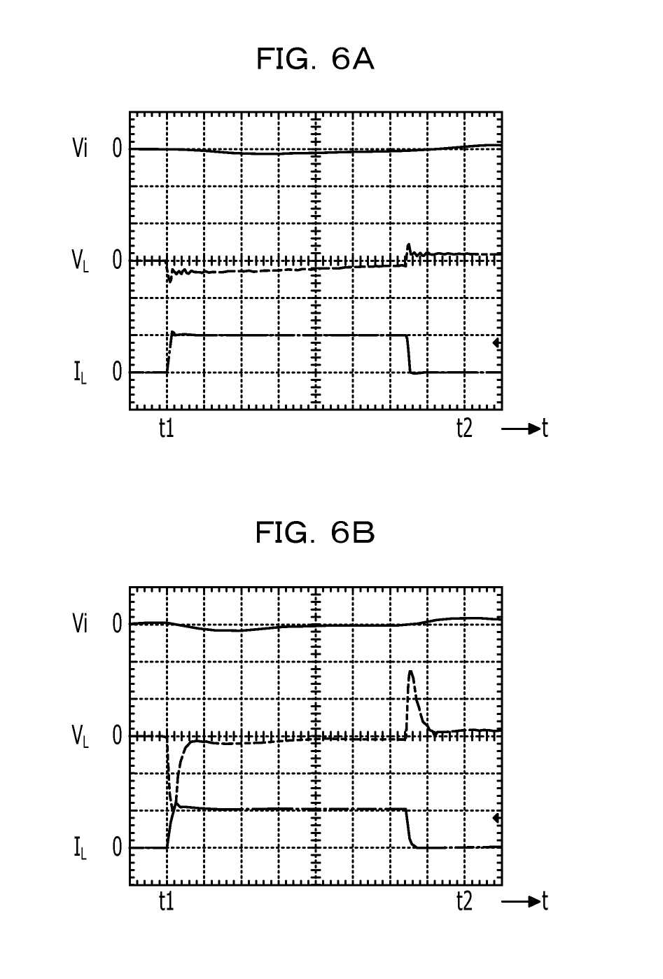

Next, a voltage waveform obtained when the power control device 100 according to the first embodiment reduces the fluctuations of the voltage V_{L} across the power terminals 14A and 14B of the CPU 14 will be described with reference to FIGS. 6A and 6B.

FIG. 6A illustrates a waveform of the voltage V_{L}, which is obtained when power is supplied under the control of the power control device 100 according to the first embodiment.

FIG. 6B illustrates a waveform obtained when the voltage V_{L} is fluctuated according to a comparative example. In each of FIGS. 6A and 6B, the lateral axis (time axis) is of the order of microseconds, such as 5 μs/div or around.

When a current I_{L} is supplied at time t1, which increases the current passing through the wire 12, as illustrated in FIG. 6A, a voltage fluctuation (L_{S}·dI_{L}/dt) occurs due to the parasitic inductance. However, since the capacitance of the variable capacitance element 101 is set in advance through the process illustrated in FIG. 5, the fluctuations of the voltage V_{L} are small. Likewise, the voltage fluctuation (L_{S}·dI_{L}/dt) due to the parasitic inductance occurs when the current I_{L} is reduced at time t2. However, since the capacitance of the variable capacitance element 101 has been set, the fluctuations of the voltage V_{L} are small. Further, a power voltage V1 is also stable.

On the other hand, when the capacitance of the variable capacitance element 101 is not sufficiently large and the current I_{L} is increased at the time t1, the voltage fluctuation (L_{S}·dI_{L}/dt) due to the parasitic inductance is not reduced, causing the voltage V_{L} to be significantly decreased as illustrated in FIG. 6B. Further, when the current I_{L} is decreased at the time t2, the voltage fluctuation (L_{S}·dI_{L}/dt) due to the parasitic inductance is not reduced, causing the voltage V_{L} to be significantly increased. Further, the power voltage V1 is also affected and fluctuates as compared to the case of FIG. 6A.

Thus, it is difficult to reduce the voltage fluctuation (L_{S}·dI_{L}/dt) due to the increase or decrease of the current passing through the wire 12 and the voltage V_{L} across the terminals 14A and 14B of the CPU 14 is significantly fluctuated when the capacitance of the variable capacitance element 101 is not sufficiently large. Under these circumstances, it is difficult to cope with a high-speed and large-amplitude voltage fluctuation occurring in a load element such as the CPU 14.

On the contrary, as described above, the power control device 100 according to the first embodiment can reduce the voltage fluctuation (L_{S}·dI_{L}/dt) due to the parasitic inductance caused by the fluctuations of current passing through the wire 12 (load fluctuations) by controlling the capacitance of the variable capacitance element 101 in accordance with the performance, the type, and the like of the load element of the CPU 14. As a consequence, the power control device 100 can maintain the voltage V_{L} in a stable state. Since the power can be stably supplied through the wire 12, it becomes possible to cope with a high-speed and large-amplitude voltage fluctuation in a load element such as the CPU 14, and supply power with stability in response to a high-speed operation and in accordance with the performance, the type, and the like of the load element of the CPU 14.

Since the variable capacitance element 101 can be set to have the capacitance value corresponding to fluctuations of the voltage across terminals of a load element such as the CPU 14 as described above, the total capacitance of an information communication apparatus such as a server apparatus or a network apparatus can be decreased as compared to the case where a large-capacity bypass capacitor with a fixed value is mounted. As a result, it becomes possible to reduce the voltage change caused by the load fluctuations occurring in an information communication apparatus such as a server apparatus or a network apparatus. Since the voltage change is reduced, it is also possible to reduce the size and cost of the information communication apparatus.

In the above-described embodiment, the control unit 104 is a CPU. However, the control unit 104 may be an analog circuit using an operational amplifier or the like. When the control unit 104 is an analog circuit, the setting of the capacitance value, which is described with reference to the flowchart of FIG. 5, is achieved through a feedback control performed by the analog circuit.

Further, in the above-described embodiment, power is supplied to the CPU 14 that is a load element. However, the load element to which the power is stably supplied under the control of the power control device according to the first embodiment may be, for example, a semiconductor device including an LSI circuit, a CPU, an FPGA, etc.

Further, in the above-described embodiment, the variable capacitance element 101 is a circuit including many resistors and switches as illustrated in FIG. 4. However, the circuit configuration of the variable capacitance element 101 is not limited to that illustrated in FIG. 4, as long as the variable capacitance element 101 is an element that can change its capacitance.

Further, in the above-described embodiment, the capacitance value of the variable capacitance element 101 is minimized at the initial stage where the capacitance value of the variable capacitance element 101 is set. However, the capacitance value at the initial stage may not necessarily be limited to the minimized value, but may be an arbitrary initial value. Further, the capacitance value may not necessarily be increased in stages.

### Second Embodiment

The configuration of a variable capacitance element 201 provided in a power control device according to a second embodiment is different from that of the first embodiment. The variable capacitance element 201 is different from the variable capacitance element 101 described in the first embodiment in that transistors are used in the variable capacitance element 201. Accordingly, the process to increase the capacitance Cv of the variable capacitance element 201, which is performed by the control unit 104, is different from that performed in the first embodiment. Since other components of the second embodiment are the same as those of the first embodiment, the same components are indicated by the same reference numerals and the descriptions thereof are omitted. The difference between the first and second embodiments will be described in the following.

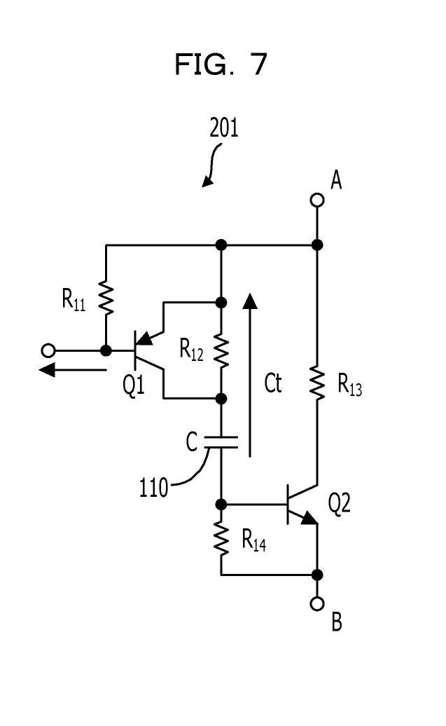

FIG. 7 illustrates the variable capacitance element 201 in the power control device according to the second embodiment. The variable capacitance element 201 includes a capacitor 110, a PNP bipolar transistor Q1, an NPN bipolar transistor Q2, and resistors R₁₁ to R₁₄. The variable capacitance element 201 is connected between the terminals A and B in place of the variable capacitance element 101 illustrated in FIG. 2.

The emitter of the PNP bipolar transistor Q1 is connected to the terminal A and the collector thereof is connected to the capacitor 110 (an electrode provided on the side of the terminal A). The base of the transistor Q1 is connected to the control unit 104 illustrated in FIG. 3 so that the control unit 104 controls the base current of the transistor Q1. The resistor R₁₁ is a base resistor connected between the base and the emitter of the transistor Q1, and the resistor R₁₂ is connected between the emitter and the collector of the transistor Q1.

The collector of the NPN bipolar transistor Q2 is connected to the terminal A via the resistor R₁₃ and the emitter thereof is connected to the terminal B. The base of the transistor Q2 is connected to the capacitor 110 (an electrode provided on the side of the terminal B). The resistor R₁₄ is connected as a base resistor between the base of the transistor Q2 and the terminal B.

In the variable capacitance element 201 according to the second embodiment, the PNP bipolar transistor Q1 and the resistor R₁₂ connected in parallel between the emitter (a current input terminal) and the collector (a current output terminal) of the transistor Q1 are used to control the capacitance, and the NPN bipolar transistor Q2 is used for amplification thereof. Hereinafter, the operating principles of the variable capacitance element 201 will be described.

In the variable capacitance element 101 used in the first embodiment, the control unit 104 closes the switches S₂ to S_{N}, S_{X}, and S₁ one by one in this order at operation S2. However, the variable capacitance element 201 used in the second embodiment is controlled so that the base current of the PNP bipolar transistor Q1 is increased in stages.

Since the emitter-base region of the PNP bipolar transistor Q1 is connected in parallel with the resistor R₁₂, the combined resistance value of the transistor Q1 and the resistor R₁₂ is changed by controlling the base current of the transistor Q1.

Accordingly, the PNP bipolar transistor Q1, the resistor R₁₂, and the capacitor 110 are considered as a single capacitor having a capacitance Ct. In that case, the capacitance Ct can be controlled by controlling the base current of the transistor Q1. When the base current of the transistor Q1 is small, the value of a resistance between the emitter and the collector of the transistor Q1 is high, so that the combined resistance value is increased and the capacitance Ct is decreased. On the other hand, when the base current of the transistor Q1 is increased, the value of the resistance between the emitter and the collector of the transistor Q1 is decreased. As a consequence, the combined resistance value is decreased and the capacitance Ct is increased. Thus, the capacitance Ct can be changed by controlling the base current of the transistor Q1.

Further, as illustrated in FIG. 7, since power is supplied to the base of the NPN bipolar transistor Q2 via the PNP bipolar transistor Q1, the resistor R₁₂, and the capacitor 110, the base current is amplified by the transistor Q2.

Therefore, between the terminals A and B, the capacitance Ct is multiplied by the amplification factor h_{fe} of the NPN bipolar transistor Q2. Accordingly, the capacitance of the variable capacitance element 201 can be expressed as h_{fe}·Ct.

When the value of the base current of the PNP bipolar transistor Q1 is zero in the initial state and the base current is increased in stages at operation S2 while the same processing operations as those of operations S1 to S4 of the first embodiment are performed repeatedly in the power control device according to the second embodiment, which includes the above-described variable capacitance element 201, the capacitance of the variable capacitance element 201 can be increased in stages.

Therefore, the power control device according to the second embodiment allows the control unit 104 to control the base current of the PNP bipolar transistor Q1, thereby controlling the capacitance of the variable capacitance element 201 based on the performance, the type, and the like of a load element such as the CPU 14. As a consequence, it becomes possible to reduce the voltage fluctuation (L_{S}·dI_{L}/dt) in the parasitic inductance due to the fluctuations of the current passing through the wire 12 (load fluctuations), so that the voltage V_{L} across the power terminals 14A and 14B of the CPU 14 can be maintained in a stable state.

Since power can be stably supplied through the wire 12, it becomes possible to cope with a high-speed and large-amplitude voltage fluctuation occurring in a load element such as the CPU 14, and supply power with stability in response to a high-speed operation and in accordance with the performance, the type, etc. of the load element such as CPU 14.

In the above-described embodiment, the variable capacitance element 201 includes the capacitor 110, the PNP bipolar transistor Q1, the NPN bipolar transistor Q2, and the resistors R₁₁ to R₁₄. However, the configuration of the variable capacitance element 201 is not limited to that illustrated in FIG. 7.

Further, in the above-described second embodiment, the variable capacitance element 201 illustrated in FIG. 7 includes the NPN bipolar transistor Q2 as an amplification circuit provided to make the capacitance greater. However, without being limited to the transistor Q2, the above-described amplification circuit may be a mirror circuit, for example. Further, the variable capacitance element 101 of the first embodiment may additionally include the above-described amplification circuit.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Although the embodiments of the present inventions have been described in detail, it should be understood that various changes, substitutions, and alterations could be made hereto without departing from the spirit and scope of the invention.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A power control device that is connected to a line supplying power from a power supply device to a load element and that stabilizes the power supply performed through the line, the power control device comprising:
a variable capacitance element connected in parallel with the load element; and
a control unit controlling a capacitance of the variable capacitance element, the control unit maintaining a degree of a voltage fluctuation due to a parasitic inductance of the line such that the degree of the voltage fluctuation is not more than a certain degree.

2. The power control device according to claim 1, wherein the variable capacitance element includes a capacitance element and a variable resistance element connected in series with the capacitance element, and the control unit changes a resistance value of the variable resistance element so that the capacitance of the variable capacitance element is controlled.

3. The power control device according to claim 2, wherein the variable resistance element includes two or more resistance elements that are connected in parallel with each other, and a switch unit configured to switch between supply and interruption of a current provided for each of the resistance elements, and wherein the control unit switches the switching unit, so that the resistance value of the variable resistance element is changed.

4. The power control device according to claim 2, wherein the variable resistance element includes a semiconductor element having a current input terminal, a current output terminal, and a current control terminal, and a resistance element connected in parallel between the current input terminal and the current output terminal, and wherein a current input to the current control terminal is controlled by the control unit and a value of a resistance provided between the current input terminal and the current output terminal is changed, so that the resistance value of the variable resistance element is changed.

5. An information communication apparatus comprising:
a load element;
a power supply device configured to supply power to the load element;
a variable capacitance element connected in parallel with the load element; and
a control unit configured to control a capacitance of the variable capacitance element, the control unit maintaining a degree of a voltage fluctuation due to a parasitic inductance of the line such that the degree of the voltage fluctuation is not more than a certain degree.
